(19) United States
(12) Patent Application Publication
(10) Pub. No.: US 2012/0285974 A1
(43) Pub. Date: Nov. 15, 2012

(54) HEAT RESISTING CUP SLEEVE

(76) Inventor: Robert Dale Hanel, Los Angeles, CA (US)

(21) Appl. No.: 13/367,656

(22) Filed: Feb. 7, 2012

Related U.S. Application Data
(63) Continuation-in-part of application No. 13/068,519, filed on May 13, 2011, now abandoned.

(51) Int. Cl. B65D 25/20; B31B 1/14

(52) U.S. Cl. 220/739; 493/340

(57) ABSTRACT

A cup holder sleeve is formed in accordance with the method comprising the steps of feeding corrugated paperboard into a lithograph press, the corrugated paper including a first surface and a second surface; engaging the corrugated paperboard with an impression cylinder having a perforated metal plate secured thereabout such that the corrugated paperboard is de-bossed with air channels formed in the first surface of the corrugated paper; die cutting the corrugated paperboard into a long, flat band; and gluing first and second side edges of the band at overlapping surfaces of the first and second side edges to create the resulting cup holder sleeve with the first surface defining the inner surface of the resulting cup holder sleeve.

### CROSS REFERENCE TO RELATED APPLICATION

This application is a continuation in part of U.S. patent application Ser. No. 13/068,519, entitled “HEAT RESISTING CUP SLEEVE”, filed May 13, 2011, which is currently pending.

### BACKGROUND OF THE INVENTION

1. Field of the Invention

This invention relates to a means for protecting the user of a paper cup from the heat of a hot beverage. More particularly, the present invention relates to a cup holder sleeve for use as an insulator on a container of a hot beverage such as coffee, tea, hot cocoa, etc.

2. Description of the Related Art

Although there are many types of insulating sleeves in use today, there is still a need for a sleeve that is inexpensive to produce, stores easily, is environmentally friendly, and most importantly protects the user's hand from the hot beverage in the container.

### SUMMARY OF THE INVENTION

It is, therefore, an object of the present invention to provide a cup holder sleeve. The cup holder sleeve is formed in accordance with the method comprising the steps of feeding corrugated paperboard into a lithograph press, the corrugated paper including a first upper surface and a second surface; engaging the corrugated paperboard with an impression cylinder having a perforated metal plate secured thereabout such that the corrugated paperboard is de-bossed with air channels formed in the first surface of the corrugated paper; cutting the corrugated paperboard into a long, flat band; and securing first and second side edges of the band at overlapping surfaces of the first and second side edges to create the resulting cup holder sleeve with the first surface defining the inner surface of the resulting cup holder sleeve.

It is also an object of the present invention to provide a cup holder sleeve wherein the perforated metal plate has a thickness of 0.048 inches.

It is another object of the present invention to provide a cup holder sleeve wherein the perforated metal plate is 51% open and 49% closed.

It is a further object of the present invention to provide a cup holder sleeve including the step of printing upon the second surface of the corrugated paperboard.

It is also an object of the present invention to provide a cup holder sleeve wherein the corrugated paperboard is composed of a fluted corrugated sheet positioned between two flat linerboards.

It is another object of the present invention to provide a cup holder sleeve wherein the corrugated paperboard is E flute corrugated paperboard.

It is a further object of the present invention to provide a cup holder sleeve wherein the corrugated paperboard has a thickness of approximately 0.057 inch.

It is also an object of the present invention to provide a cup holder sleeve wherein the air channels are defined by a plurality of spaced protuberances extending from a base surface of the inner surface of the cup holder sleeve.

It is another object of the present invention to provide a cup holder sleeve wherein the air channels extend from a top edge of the cup holder sleeve to a bottom edge of the cup holder sleeve.

It is a further object of the present invention to provide a cup holder sleeve comprising a long, flat band made from paperboard material. The band includes first and second side edges that are glued together at overlapping surfaces of the first and second side edges. The cup holder sleeve also includes an inner surface and an outer surface, wherein the inner surface includes a plurality of air channels which permit the flow of air between the cup holder sleeve and a cup, and the outer surface is substantially smooth. The paperboard material is corrugated paperboard.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a bottom plan view of a band in accordance with the present invention.

FIG. 2 is a side plan view of a cup sleeve in accordance with the present invention showing the ends of the band secured together to form the sleeve.

FIG. 3 is a perspective view of the cup sleeve.

FIG. 4 is a perspective view of a cup sleeve with a cup positioned therein.

FIG. 4A is a cross sectional view along the line 4A-4A in FIG. 4.

FIG. 5 is a schematic view of the Planeta lithograph press.

FIG. 5A is a cross sectional view of the impressed paperboard used in the manufacture of the cup sleeve.

FIG. 6 is a side view of the impression cylinder used in the lithograph press in accordance with the present invention.

FIG. 6A is a detailed top plan view of the perforated metal plate.

FIG. 7 shows the layout for one press sheet with 70 bands up on the 40×55 inch Planeta lithograph press.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

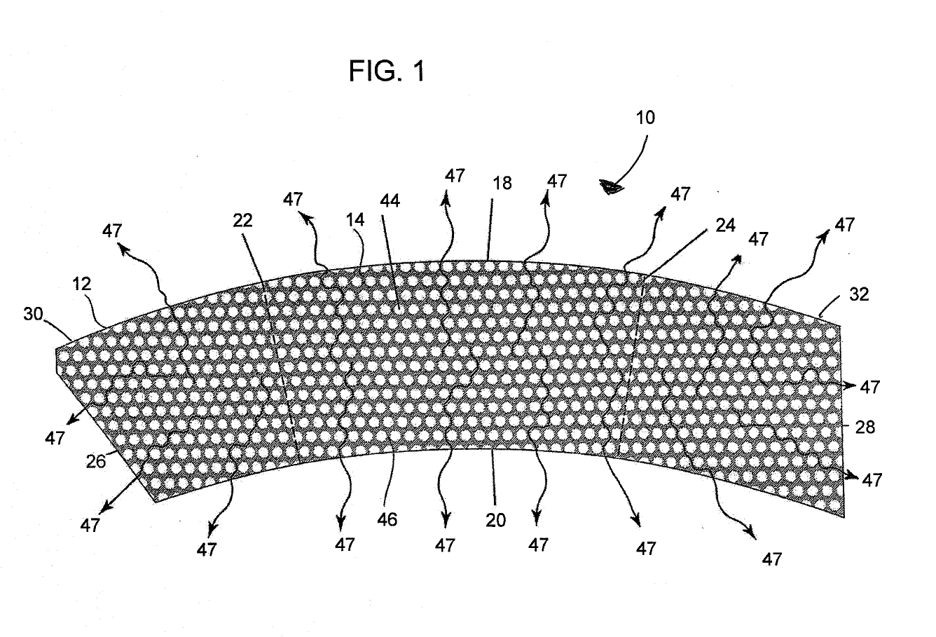

In accordance with the present invention, and with reference to FIGS. 1 to 7, a cup holder sleeve 10 in accordance with the present invention is disclosed. This invention provides beverage container holders (sleeves) which are environmentally friendly and which provide adequate insulation for protection from hot beverages.

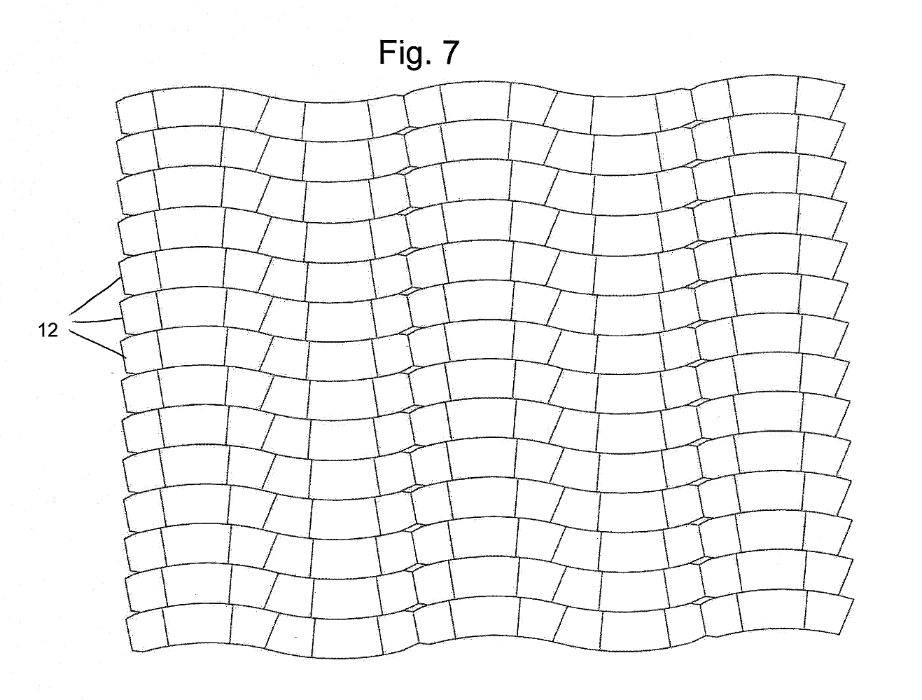

As shown in FIG. 1, the cup holder sleeve 10 is composed of a long, flat band 12 made from paperboard material. The band 12 includes a first surface 14 (which is the lower surface as the paperboard passes through the press and becomes the inner surface of the resulting cup holder sleeve 10) and an opposed second surface 16 (which is the upper surface as the paperboard passes through the press and becomes the gripping outer surface of the resulting cup holder sleeve 10). The cup holder sleeve 10 also includes a top edge 18 and a bottom edge 20 running along the long length of the flat band 12. The top edge 18 and the bottom edge 20 are curved edges which run substantially parallel to each other. Because the top edge 18 and the bottom edge 20 are parallel to each other, a common die cutting knife may be used in the formation of the flat band 12 from which the present cup holder sleeve 10 is formed. The one knife will simultaneously cut the top edge 18 of one sleeve and the bottom edge 20 of an adjacent sleeve. This eliminates the need for the use of two die cutting knives with space between the sleeves and thus uses a minimum of paperboard material, eliminating waste (good for the environment) and saving material (improving the cost). (See FIG. 7)

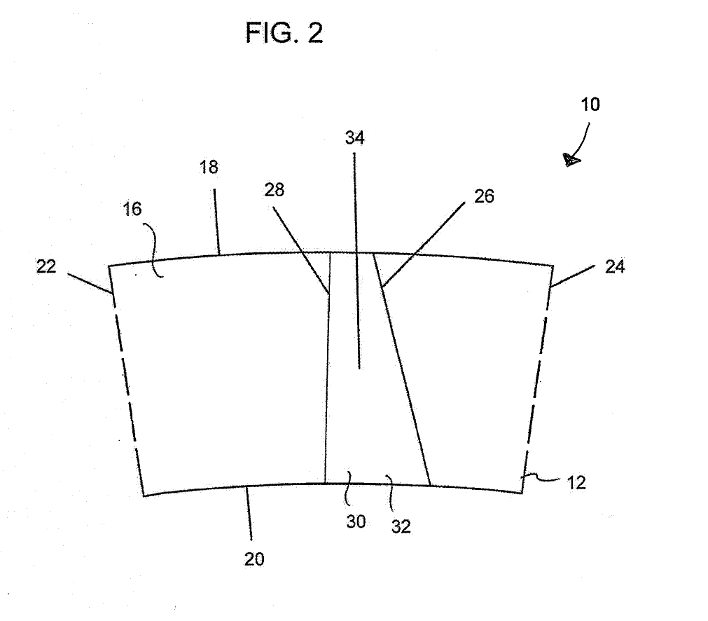

The flat band 12 of the cup holder sleeve 10 includes first and second fold lines 22, 24 scored into the flat band 12 at spaced apart positions. The first and second fold lines 22, 24 taper toward each other such the resulting cup holder sleeve 10 may be stored in a compact flat configuration as appreciated based upon the following discussion and as shown with reference to FIG. 2. The flat band 12 also includes first and second side edges 26, 28 at opposite ends of the flat band 12 with the top edge 18 and the bottom edge 20 extending therebetween.

In practice, the opposite first and second ends 30, 32 of the flat band 12 are folded flat at the respective first and second fold lines 22, 24, so that the first and second side edges 26, 28 overlap each other. The first and second side edges 26, 28 are glued together at their overlapping surfaces 34. The resulting flat-folded cup holder sleeve 10 is thus pre-assembled and allows for compact storage.

When a user desires to place the cup holder sleeve 10 into use, the cup holder sleeve 10 is pressed bringing the folds lines 22, 24 toward each other and expanding the flat cup holder sleeve 10 into a substantially circular configuration. The bottom 36 of the cup 38 is slid within the opening 40 defined by the cup holder sleeve 10. Thereafter, the cup 38 is slid downwardly until the inner surface 14 of the cup holder sleeve 10 comes into contact with the outer surface 42 of the cup 38. Because of the tapered nature of the cup 38, the cup holder sleeve 10 will settle at a position approximately at the center of the cup 38 for engagement by a person as he or she grabs the cup holder sleeve 10 with the cup 38 positioned therein and drinks therefrom.

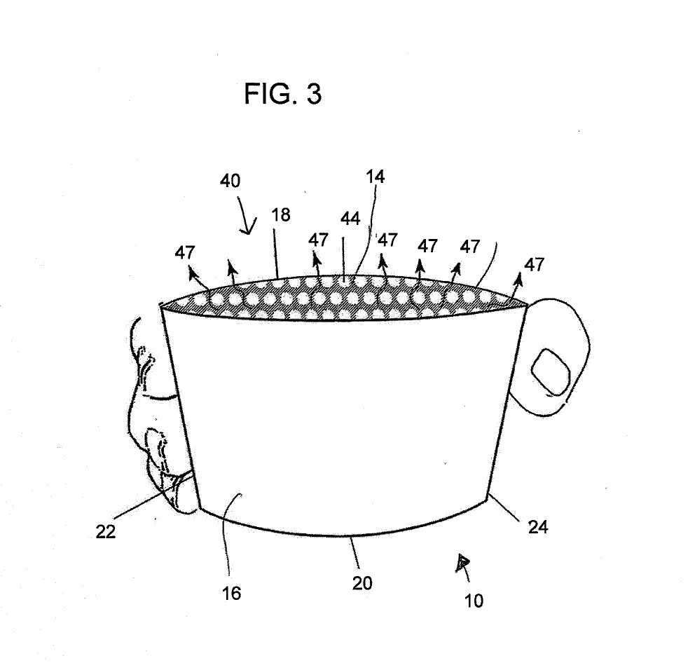

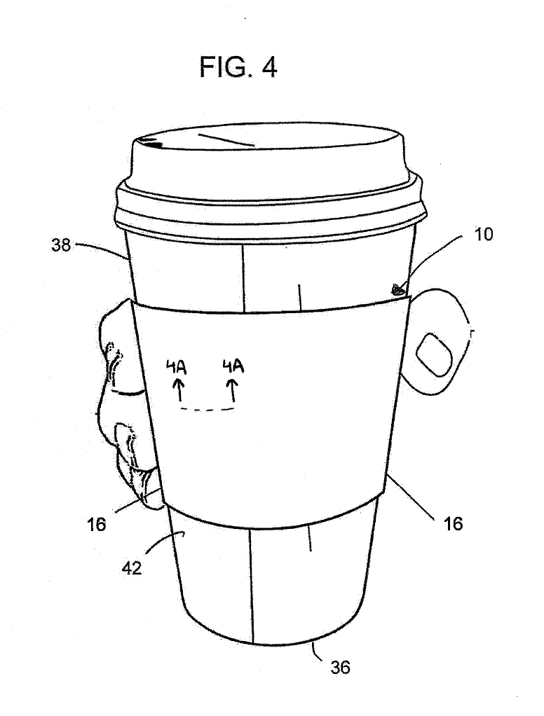

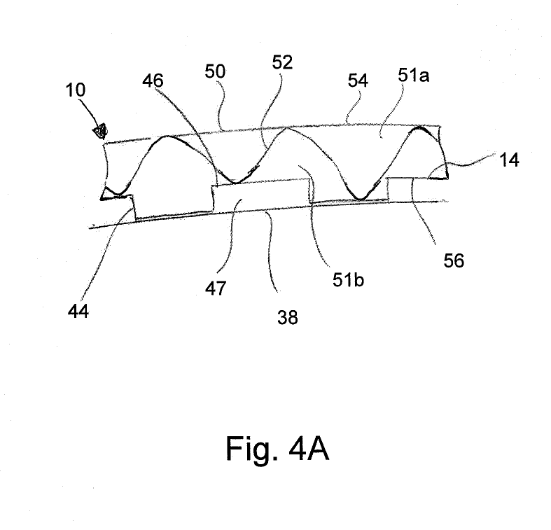

Because of the construction of the cup holder sleeve 10 along the inner surface 14 thereof, the transfer of heat from the cup 38 containing hot liquid is minimized, thereby maintaining a comfortable surface upon which to hold the cup 38. In particular and as briefly discussed above, the cup holder sleeve 10 includes an inner surface 14 and an outer surface 16. The outer surface 16 is substantially smooth for printing thereupon as desired by the vendor providing the cup holder sleeve 10. Referring in particular to FIGS. 3, 4 and 4A, the inner surface 14 includes a plurality of air channels or passageways 47 which permit the flow of air between the cup holder sleeve 10 and the cup 38. The air channels 47 are defined by a plurality of spaced protuberances 44 extending from the base surface 46 of the inner surface 14 of the cup holder sleeve 10. The air channels 47 permit the flow of air between the cup 38 and the cup holder sleeve 10 when the cup holder sleeve 10 is positioned about the cup 38. The passageways 47 are defined by spaces between the base surface 46 of the inner surface 14 of the cup holder sleeve 10 as the protuberances 44 come directly into contact with the outer surface 42 of the cup 38 when the cup holder sleeve 10 is secured thereabout.

The passageways 47 along the inner surface 14 are formed by de-bossing the paperboard material from which the cup holder sleeve 10 is formed. In this way, the present invention allows for manufacture of a cup holder sleeve 10 having a smooth outer surface 16 appropriate for printing thereon so as to provide an aesthetically pleasing cup holder sleeve 10 and an inner surface 14 providing for effective spacing from the outer surface 42 of a hot cup 38 which it is positioned about.

The cup holder sleeve 10 is therefore manufactured in a distinctive manner. In particular, the process of manufacturing cup holder sleeves 10 in accordance with the present invention is initiated with E flute corrugated paperboard 50 having a thickness of approximately 0.057 inch. As is appreciated, and in accordance with the present invention, the corrugated paperboard is composed of a fluted corrugated sheet 52 positioned between two flat linerboards 54, 56. The fluted corrugated sheet 52 and the linerboards 54, 56 are adhesively bound together to form a single integral sheet of paperboard 50. E flute paperboard as employed in accordance with the present invention is commonly manufactured with 90+/−4 flutes per linear foot and exhibiting a flute thickness (that is, the thickness of the central fluted corrugated sheet) of 0.057 inch.

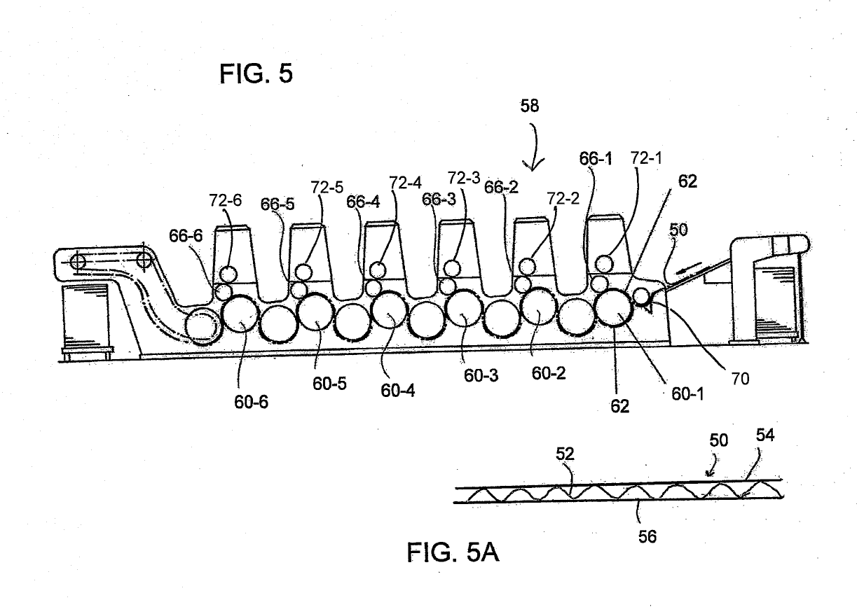

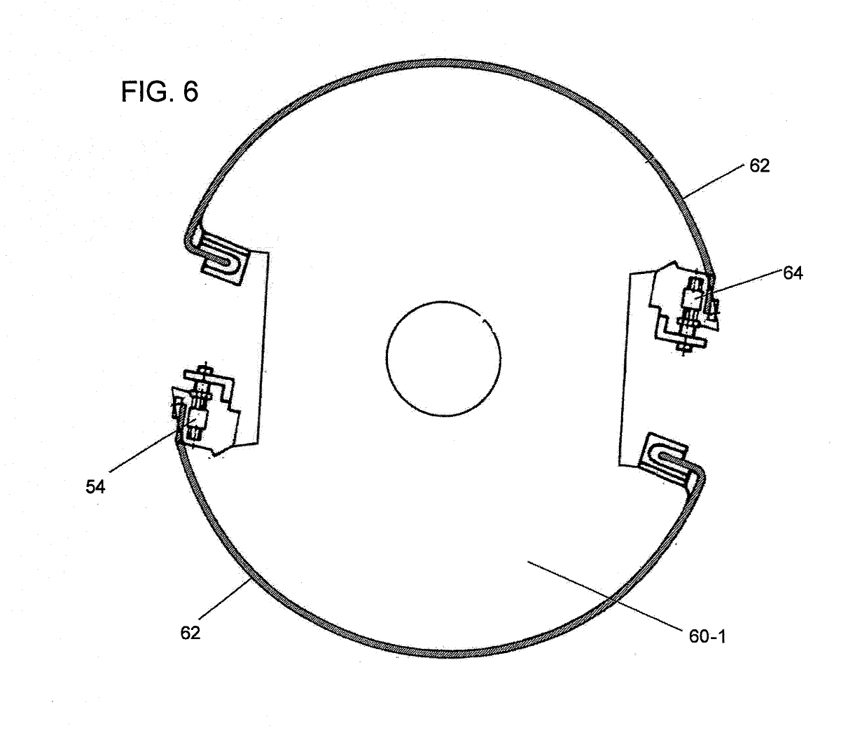

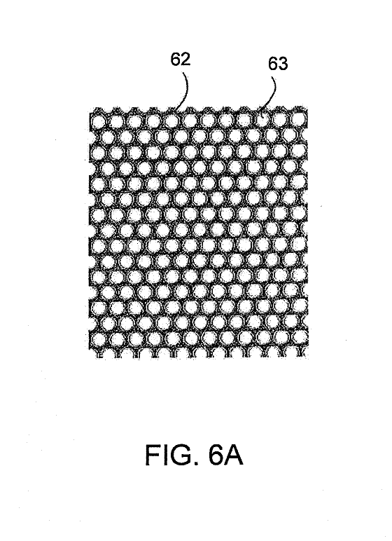

Once the paperboard 50 is ready, and with reference to FIGS. 5, 6, 6A and 7, it is fed into a lithograph press 58 modified in accordance with the present invention. In accordance with a preferred embodiment, the lithographic press 58 is a Planeta 40×55 inch Lithograph Press. The paperboard 50 is fed into the lithograph press 58 by a feed roller 70 and is engaged by an impression cylinder 60-1 with two perforated metal plates 62 secured thereabout. In particular, the two perforated metal plates 62 are secured to an impression cylinder 60-1 and tensioned thereabout using two threaded tension plates 64 securely holding the two perforated metal plates 62 about the impression cylinder 60-1. In accordance with a preferred embodiment, and with reference to FIG. 6A, the perforated metal plates 62 have a thickness of 0.048 inch and include a plurality of perforations 63. The perforations 63 are shaped as circular apertures in the metal plate such that the perforated metal plate 62 is 51% open (that is, with apertures/perforations formed therein) and 49% closed (that is, solid metal). In addition, the preferred embodiment includes perforations 63 formed with a diameter of 3/16 of an inch. The open portions of the perforated metal plate 62 result in the protuberances 44 that directly contact the cup 38, and the present cup holder sleeve 10 therefore offers 51% direct contact with the cup 38.

As the paperboard 50 passes by the two perforated metal plates 62, a compression/printing roller 66-1 applies pressure to the paperboard 50 in the direction of the perforated two metal plates 62. The extent of the pressure applied by the compression/printing roller 66-1 is controlled by adjusting the position of the print plate cylinder 72-1. In particular, the paperboard 50 passes through the lithograph press 58 with the second surface 16 (that is, the surface of the paperboard 50 that ultimately results in the outer surface of the cup holder sleeve 10) facing the compression/printing roller 66-1 and the first surface 14 (that is, the surface of the paperboard 50 that ultimately results in the inner surface of the cup holder sleeve 10) facing the two perforated metal plates 62. In this way, the contact of the outer or second surface 16 with the compression/printing roller 66-1 results in the application of a desired outer surface 16 of the of the cup holder sleeve 10 while the inner or first surface 14 is pressed against the two perforated metal plates 62 and portions thereof pass through the apertures while other portions thereof are supported by the solid portion of the two perforated metal plates 62 resulting in the de-bossing of the paperboard 50 along the second linerboard 56 and the formation of the protuberances 44 and passageways 47.

With particular reference to FIG. 4A, and as briefly discussed above, the de-bossing of the paperboard 50 results in the formation of spaced protuberances 44 along the second linerboard 56, that is, along the inner surface 14 of the cup holder sleeve 10. The protuberances 44 extend from the base surface 46 of the inner surface 14 of the cup holder sleeve 10, that is, the base surface of the second linerboard 56 of the paperboard 50. The protuberances 44 define the air channels 47 permitting the flow of air between the cup 38 and the cup holder sleeve 10 when the cup holder sleeve 10 is positioned about the cup 38.

In addition to the spacing between the cup 38 and the cup holder sleeve 10 defined by the air channels 47, the de-bossing of the paperboard 50 results in air pockets 51a, 51b within the processed paperboard 50 that also enhances the insulation provided by the cup holder sleeve 10. The air pockets 51a, 51b are a result of both the space between first linerboard 54 and the fluted corrugated sheet 52, and the second linerboard 56 and the fluted corrugated sheet 52.

As shown with reference to FIG. 5, the lithograph press 58 is provided with multiple additional stations 66-2 thru 66-6 where printing occurs. It is appreciated the provision of multiple compressing/printing rollers 66-2 through 66-6 with print plate cylinders 72-2 through 72-6 results in the ability to print in multiple colors as each print plate cylinder may be used to print in a different color. De-bossing occurs only at 66-1 and an impression cylinder 60-1 to which two perforated metal plates 62 are secured. A preferred embodiment employs simultaneous de-bossing and printing.

In particular, the application of pressure to the paperboard 50 as it is held between the two perforated metal plates 62 and the compression roller 66-1 results in de-bossing of the paperboard 50 along the first surface 14. The de-bossing thereof results in the formation of protuberances 44 and passageways 47 in the resulting cup holder sleeve 10. Once the sheet of paperboard 50 is fully de-bossed in accordance with the present invention, the sheet is die cut on a 40×55 inch Bobst die cutter, into flat unfolded blanks 12, so as to have parallel top and bottom curved edges 18, 20, see FIG. 7.

As discussed above, the ends 30, 32 of flat band 12 are adhesively secured defining the flat cup holder sleeve 10. The fold lines 22, 24 are scored into the band 12 at spaced apart positions and taper toward each other, and side edges 26, 28 at opposite ends of the band 12. The opposite ends 30, 32 are folded flat at the fold lines 22, 24 so that the side edges 26, 28 overlap each other and are glued together at their overlapping surfaces. The flat-folded form allows for compact storage.

The pre-assembled sleeve can be readied for use simply by squeezing on the outside surfaces so as to bow out the flat-folded band 12, that is, the cup holder sleeve 10 in its flat configuration, into an annular tapered sleeve with opened top and bottom ends for inserting a cup therein. In a preferred embodiment, the sleeve is made of recycled paperboard material and is printed with graphics. Also, one or more spots of heat activated glue can be applied on the inside of the sleeve if extra adhesion of the sleeve to the cup is desired. The performance of the above blank handling steps is well known in the paper products industry and is not described further within.

While the preferred embodiments have been shown and described, it will be understood that there is no intent to limit the invention by such disclosure, but rather, is intended to cover all modifications and alternate constructions falling within the spirit and scope of the invention.

1. A cup holder sleeve formed in accordance with the method comprising the following steps:
feeding corrugated paperboard into a lithograph press, the corrugated paper including a first surface and a second surface;
engaging the corrugated paperboard with an impression cylinder having a perforated metal plate secured thereabout such that the corrugated paperboard is de-bossed with air channels formed in the first surface of the corrugated paper;
cutting the corrugated paperboard into a long, flat band; and
securing first and second side edges of the band at overlapping surfaces of the first and second side edges to create the resulting cup holder sleeve with the first surface defining the inner surface of the resulting cup holder sleeve.

2. The cup holder sleeve according to claim 1, wherein the perforated metal plate has a thickness of 0.048 inches.

3. The cup holder sleeve according to claim 1, wherein the perforated metal plate is 51% open and 49% closed.

4. The cup holder sleeve according to claim 1, further including the step of printing upon the second surface of the corrugated paperboard.

5. The cup holder sleeve according to claim 1, wherein the corrugated paperboard is composed of a fluted corrugated sheet positioned between two flat linerboards.

6. The cup holder sleeve according to claim 5, wherein the corrugated paperboard is E flute corrugated paperboard.

7. The cup holder sleeve according to claim 5, wherein the corrugated paperboard has a thickness of approximately 0.057 inch.

8. The cup holder sleeve according to claim 1, wherein the air channels are defined by a plurality of spaced protuberances extending from a base surface of the inner surface of the cup holder sleeve.

9. The cup holder sleeve according to claim 8, wherein the air channels extend from a top edge of the cup holder sleeve to a bottom edge of the cup holder sleeve.

10. A cup holder sleeve, comprising:
a long, flat band made from paperboard material, the band includes first and second side edges that are glued together at overlapping surfaces of the first and second side edges,
an inner surface and an outer surface, the inner surface includes a plurality of air channels which permit the flow of air between the cup holder sleeve and a cup, and the outer surface is substantially smooth;
wherein the paperboard material is corrugated paperboard.

11. The cup holder sleeve according to claim 10, wherein the corrugated paperboard is composed of a fluted corrugated sheet positioned between two flat linerboards.

12. The cup holder sleeve according to claim 11, wherein the corrugated paperboard is E flute corrugated paperboard.

13. The cup holder sleeve according to claim 11, wherein the corrugated paperboard has a thickness of approximately 0.057 inch.

14. The cup holder sleeve according to claim 10, wherein the air channels are defined by a plurality of spaced protuberances extending from a base surface of the inner surface of the cup holder sleeve.

15. The cup holder sleeve according to claim 14, where the plurality of spaced protuberances are de-bossed.

16. The cup holder sleeve according to claim 14, wherein the air channels extend from a top edge of the cup holder sleeve to a bottom edge of the cup holder sleeve.
